(19) United States
(12) Patent Application Publication
(10) Pub. No.: US 2006/0137809 A1
(43) Pub. Date: Jun. 29, 2006

(54) Method for manufacturing a rubber sheet with a facial decorative cloth

(76) Inventor: Rong-Fen Chen, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/357,043

(22) Filed: Feb. 21, 2006

Related U.S. Application Data
(63) Continuation-in-part of application No. 10/725,119, filed on Dec. 2, 2003.

(51) Int. Cl. B32B 37/00

(52) U.S. Cl. 156/219; 156/277

(57) ABSTRACT

A method for manufacturing a rubber sheet with a facial decorative cloth. A decorative cloth layer is first overlaid on the surface of the rubber sheet. Then, the rubber sheet with the decorative cloth layer is thermally rolled to make the decorative cloth layer adhered to and firmly bonded with the rubber sheet. The decorative cloth layer is printed with predetermined ink figures. A waterproof layer is laid on one face of the decorative cloth layer opposite to the rubber sheet to achieve waterproof effect.

### REFERENCE TO RELATED APPLICATIONS

This application is a Continuation-in-Part of patent application Ser. No. 10/725,119, filed 2 Dec. 2003, currently pending.

### BACKGROUND OF THE INVENTION

The present invention is related to a method for manufacturing a rubber sheet with a facial decorative cloth. By means of this method, the decorative cloth layer is adhered to and firmly bonded with the rubber sheet with waterproof effect.

The rubber sheet is usually used as a material for waterproof shoes. For example, the rubber sheet is used in the periphery of the ramp of the shoes. For a good look, the shoes manufacturers usually print the surface of the rubber sheet with ink figures to beautify the surface of the rubber sheet.

However, the ink printed on the rubber sheet tends to detach from the rubber sheet to deteriorate the appearance thereof.

For solving this problem, some rubber sheet manufacturers use glue to adhere a decorative cloth layer to the surface of the rubber sheet. The decorative cloth layer is printed with figures for promoting the vision of the rubber sheet.

However, the cloth layer itself has water-absorbing capacity so that the cloth layer may contain water. The water contained in the cloth layer will make the glue lose its adhesion. Consequently, the cloth layer may detach from the rubber sheet.

### SUMMARY OF THE INVENTION

It is therefore a primary object of the present invention to provide a method for manufacturing a rubber sheet with a facial decorative cloth. A decorative cloth layer is combined with the rubber sheet by means of thermal pressing to make the decorative cloth layer adhered to and firmly bonded with the rubber sheet. A waterproof layer is laid on one face of the decorative cloth layer opposite to the rubber sheet to achieve waterproof effect.

It is a further object of the present invention to provide the above manufacturing method in which when the decorative cloth layer is combined with the rubber sheet by means of thermal pressing, the rubber sheet is simultaneously embossed to form recess stripes on the surface of the combination of the decorative cloth layer and the rubber sheet. The recess stripes enlarge the bonding area of the decorative cloth layer and the rubber sheet and thus enhance the bonding strength therebetween. In addition, the recess stripes promote the vision of the combination of the rubber sheet and the decorative cloth layer.

According to the above objects, the method for manufacturing the rubber sheet with the facial decorative cloth of the present invention includes steps of:
(a) preparing a rubber sheet and a decorative cloth layer;
(b) printing the decorative cloth layer with predetermined ink figures;
(c) laying a waterproof agent on one face of the decorative cloth layer opposite to the rubber sheet to form a waterproof layer;
(d) preheating the rubber sheet;
(e) overlaying the decorative cloth layer on a surface of the rubber sheet;
(f) rolling the rubber sheet with the decorative cloth layer by means of a roller unit; and
(g) forming the rubber sheet with the facial decorative cloth.

The present invention can be best understood through the following description and accompanying drawings wherein:

### BRIEF DESCRIPTION OF THE DRAWINGS

FIG. 1 is a perspective view showing the flow chart of a first embodiment of the present invention;

FIG. 2 is a sectional view of the rubber sheet with the facial decorative cloth of the present invention;

FIG. 3 is a perspective view of the rubber sheet with the facial decorative cloth of the present invention; and

FIG. 4 is a perspective view showing the flow chart of a second embodiment of the present invention.

### DETAILED DESCRIPTION OF THE PREFERRED EMBODIMENTS

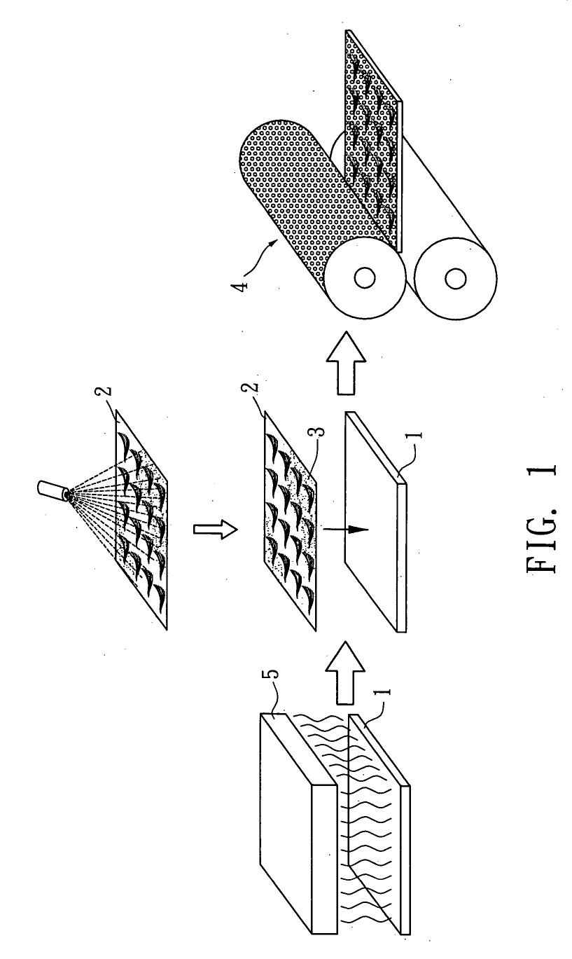

Please refer to FIGS. 1 to 4. The method for manufacturing the rubber sheet with the facial decorative cloth of the present invention includes steps of:

preparing a rubber sheet 1 and a decorative cloth layer 2, the decorative cloth layer 2 being printed with predetermined ink figures, a waterproof layer 3 being laid on one face of the decorative cloth layer 2 opposite to the rubber sheet 1;

combing the decorative cloth layer 2 and the rubber sheet 1 by means of thermal pressing, before the rubber sheet 1 is combined with the decorative cloth layer 2, the rubber sheet 1 being preheated and slightly molten as shown in FIG. 1, then the decorative cloth layer 2 being overlaid on a surface of the rubber sheet 1, whereby the rubber sheet 1 can infiltrate into the decorative cloth layer 2; and

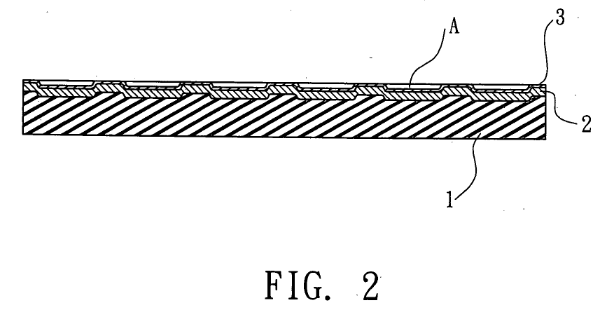

rolling the rubber sheet 1 with the decorative cloth layer 2 by means of an embossing roller unit 4 to form recess stripes A on the surface of the rubber sheet 1 as shown in FIG. 2.

In this embodiment, the waterproof layer 3 is formed on the surface of the decorative cloth layer 2 in such a manner that a waterproof agent is sprayed onto an inner face of the thermal pressing mold facing the decorative cloth layer 2. After thermally pressed, the waterproof layer 3 is formed on the surface of the decorative cloth layer 2. When the decorative cloth layer 2 is thermally pressed and adhered to the rubber sheet 1, the waterproof layer 3 serves to protect and prevent the ink printed on the decorative cloth layer 2 from spreading or detaching from the decorative cloth layer 2. Therefore, the appearance of the surface of the decorative cloth layer 2 can be maintained.

After the decorative cloth layer 2 is adhered to the rubber sheet 1, the waterproof layer 3 serves to provide water repellent effect and prevent the decorative cloth layer 2 from absorbing water. Accordingly, the decorative cloth layer 2 will not contain water to affect the adhesion between the decorative cloth layer 2 and the rubber sheet 1.

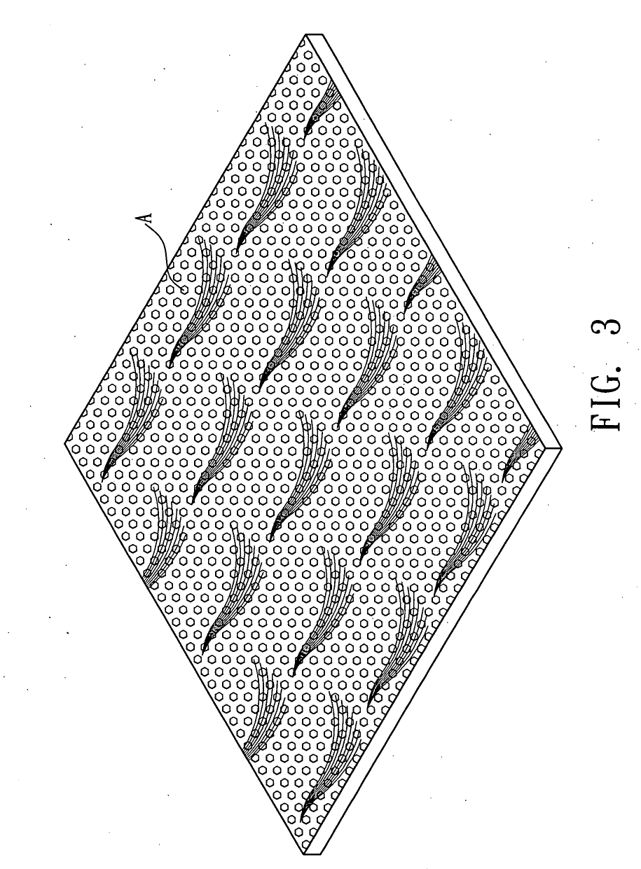

Moreover, the recess stripes A of the combination of the decorative cloth layer 2 and the rubber sheet 1 will enlarge the bonding area of the decorative cloth layer 2 and the rubber sheet 1 and thus enhance the bonding strength therebetween. In addition, the recess stripes A can beautify the appearance of the rubber sheet 1 and make the figures printed on the decorative cloth layer 2 solid as shown in FIG. 3.

The above embodiment can be modified. For example, the waterproof agent can be alternatively sprayed onto or rolled over the surface of the decorative cloth layer 2 to form the waterproof layer.

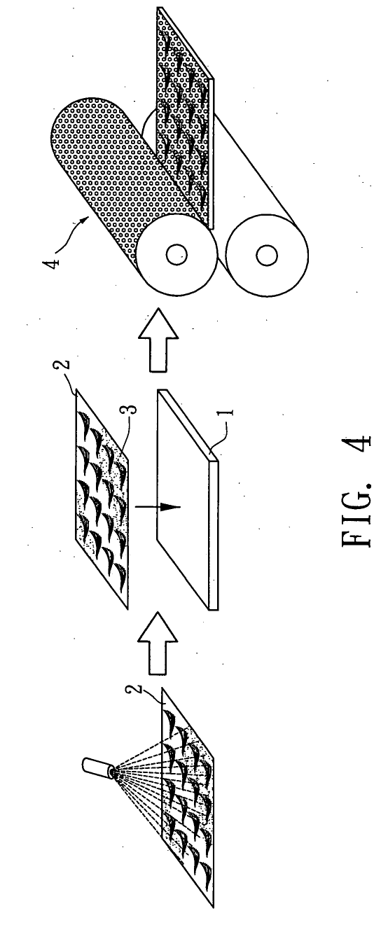

FIG. 4 shows a second embodiment of the present invention, in which the decorative cloth layer 2 is first overlaid on the surface of the rubber sheet 1. Then, the rubber sheet 1 with the decorative cloth layer 2 is rolled by means of a roller unit 4 having an internal heater. In this embodiment, the heater is an electric heating pipe. When the roller unit 4 touches the rubber sheet 1, the rubber sheet 1 is heated and molten. Accordingly, the rubber sheet 1 can infiltrate into the decorative cloth layer 2. In addition, the roller unit 4 has boss stripes on the surface so as to form recess stripes A on the surface of the rubber sheet 1.

The above embodiments are only used to illustrate the present invention, not intended to limit the scope thereof. Many modifications of the above embodiments can be made without departing from the spirit of the present invention.

What is claimed is:

1. A method for manufacturing a rubber sheet with a facial decorative cloth, comprising steps of:
(a) preparing a rubber sheet and a decorative cloth layer;
(b) printing the decorative cloth layer with predetermined ink figures;
(c) laying a waterproof agent on one face of the decorative cloth layer opposite to the rubber sheet to form a waterproof layer;
(d) preheating the rubber sheet;
(e) overlaying the decorative cloth layer on a surface of the rubber sheet;
(f) rolling the rubber sheet with the decorative cloth layer by means of a roller unit; and
(g) forming the rubber sheet with the facial decorative cloth.

2. The method for manufacturing the rubber sheet with the facial decorative cloth as claimed in claim 1, wherein a surface of the roller unit has boss stripes for forming recess stripes on the surface of the rubber sheet.

3. A method for manufacturing a rubber sheet with a facial decorative cloth, comprising steps of:
(a) preparing a rubber sheet and a decorative cloth layer;
(b) printing the decorative cloth layer with predetermined ink figures;
(c) laying a waterproof agent on one face of the decorative cloth layer opposite to the rubber sheet to form a waterproof layer;
(d) overlaying the decorative cloth layer on a surface of the rubber sheet;
(e) rolling the rubber sheet with the decorative cloth layer by means of a roller unit having an internal heater; and
(f) forming the rubber sheet with the facial decorative cloth.

4. The method for manufacturing the rubber sheet with the facial decorative cloth as claimed in claim 3, wherein a surface of the roller unit has boss stripes for forming recess stripes on the surface of the rubber sheet.

5. The method for manufacturing the rubber sheet with the facial decorative cloth as claimed in claim 3, wherein the heater is an electric heating pipe.
